(19) United States
(12) Patent Application Publication
(10) Pub. No.: US 2019/0261665 A1
(43) Pub. Date: Aug. 29, 2019

(54) SEASONING BLENDS BY COLOR

(71) Applicant: Marcus Moore, Santa Ana, CA (US)

(72) Inventor: Marcus Moore, Santa Ana, CA (US)

(21) Appl. No.: 16/262,853

(22) Filed: Jan. 30, 2019

Related U.S. Application Data
(60) Provisional application No. 62/623,988, filed on Jan. 30, 2018.

(51) Int. Cl. A23L 27/12; A23L 27/00; A23L 27/10; A23L 27/16; A23L 2/56

(52) U.S. Cl. CPC A23L 27/13; A23L 27/88; A23V 2002/00; A23L 27/16; A23L 2/56; A23L 27/105

(57) ABSTRACT

A seasoning blend is provided that includes ingredients derived from any combination of a fruit, vegetable and herb/spice. The ingredients themselves or the food source from which the ingredients are derived may further be of the same or complementary color. A method for providing cooking instructions that refer to the seasoning blends by the color of the seasoning blend is also provided.

### CROSS-REFERENCE TO RELATED APPLICATIONS

This application claims priority to U.S. Provisional application 62/623,988, titled SEASONING BLENDS BY COLOR, filed on Jan. 30, 2018, which is incorporated by reference herein in its entirety.

### FIELD OF THE INVENTION

The invention relates to seasoning blends and methods for cooking with such seasoning blends, as well as cooking recipes and cooking instructions that use seasoning blends.

### BACKGROUND OF THE INVENTION

Various types of seasonings are known to enhance the flavor for a variety of food products. Most seasonings include a combination of herbs, spices and salts. Most seasonings are not, however, derived from a variety of different food groups that can support a wide-range of diets.

Seasonings typically comprise of one ingredient (e.g. oregano, basil, or paprika) or comprise of a combination of ingredients derived from the same food group. Additionally, seasonings comprised of more than one ingredient are derived from food groups that are of different colors, which creates a multi-colored seasoning blend. These multi-colored seasoning blends not only lack vibrant colors, which is shown to stimulate the mind and provide good health, but also lack a uniformity in flavor and aroma.

Thus, a need exists to create non-traditional natural and flavorful seasoning blends that are comprised of ingredients from different food groups and that have vibrant uniform colors that enhances flavor and caters to all dietary restrictions and lifestyles.

### SUMMARY OF THE INVENTION

The present invention relates to a new philosophy towards cooking and a healthy lifestyle based upon the combination of fruits, vegetables and herbs/spices in a seasoning blend, where the combination of fruits, vegetables and herbs/spices are all derived from food sources being of a complementary or similar color. By combining ingredients of like color, one achieves a flavor profile of non-intuitive, but complementary components. Such combination can be derived entirely from purely natural ingredients, which support a wide range of diets, including individuals dealing with high blood pressure and diabetes. Additionally, the combination is free of sodium, GMO, MSG, preservatives, gluten, and other additives.

In one example, the present invention may include a seasoning blend for flavoring food products, where the seasoning blend comprises a combination of ingredients derived from at least two of the following food groups: fruit, vegetable and herb/spice. Any type of fruit, vegetable, or herb/spice found in the market can be used in the seasoning blend.

In another example, a seasoning blend may comprise of a combination of ingredients derived from at least one fruit, at least one vegetable and at least one herb/spice where the colors of the at least one fruit, at least one vegetable and at least one herb/spice are all from the same color group. As will be explained in more detail below, a color group may consist of colors located within three adjacent color families on a twelve hue color wheel, or colors located within two adjacent color families on a twelve hue color wheel, or colors located within one color family on a twelve hue color wheel. Additionally, while in some examples, the seasoning blend may include ingredients that are all of a color in the same color group, other examples may provide a seasoning blend where the colors of the food sources from which the ingredients of a seasoning blend are derived are all in the same color group.

Additionally, a method for providing cooking instructions is provided, where the method comprises providing seasoning blends of a particular color, and providing cooking instructions that refer to the seasoning blend by the color of the seasoning blend or by a name assigned to the seasoning color. By referring to a seasoning blend by its color, rather than by its ingredients, cooking instructions are made easier to understand and follow, particularly for individuals with disabilities, college students, novice cooks, or anyone who desires a simpler or easier way to cook and follow cooking instructions.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. This patent or application file contains at least one drawing executed in color. Copies of this patent or patent application publication with color drawing(s) will be provided by the Office upon request and payment of the necessary fee.

FIG. 1A shows examples of certain seasoning blends of the present invention that have been prepared by combining ingredients derived from food sources from different food groups based upon the similarity of color of the food sources.

FIG. 1B shows examples of some of the seasoning blends of FIG. 1A combined with an Agave sweetener base.

FIG. 1C shows examples of some of the seasoning blends of FIG. 1A combined with an Avocado oil base.

FIG. 2A is an illustration of a color wheel comprising of twelve different color families.

FIG. 2B is an example of a color family of the color wheel of FIG. 2A.

FIGS. 3A-3F are tables showing the categories of food groups included in the seasonings of the present invention, along with examples of percentage ranges of the food groups that may be found in the seasonings.

FIG. 3G is a table that provides various combinations of percentages of fruits, vegetables and herbs/spices taken from similar colored foods that may be combined together to create the seasoning blends of the present invention.

FIGS. 4A-4C are examples of recipes and corresponding cooking instructions that refer to the seasonings of the present invention by color.

### DETAILED DESCRIPTION OF THE FIGURES

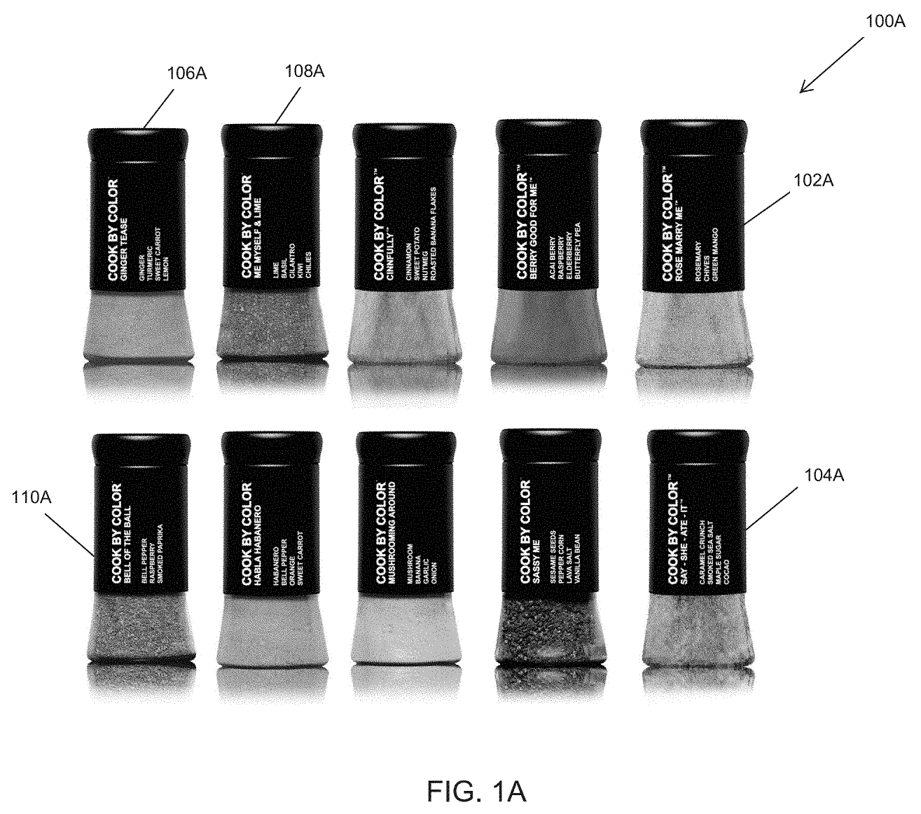

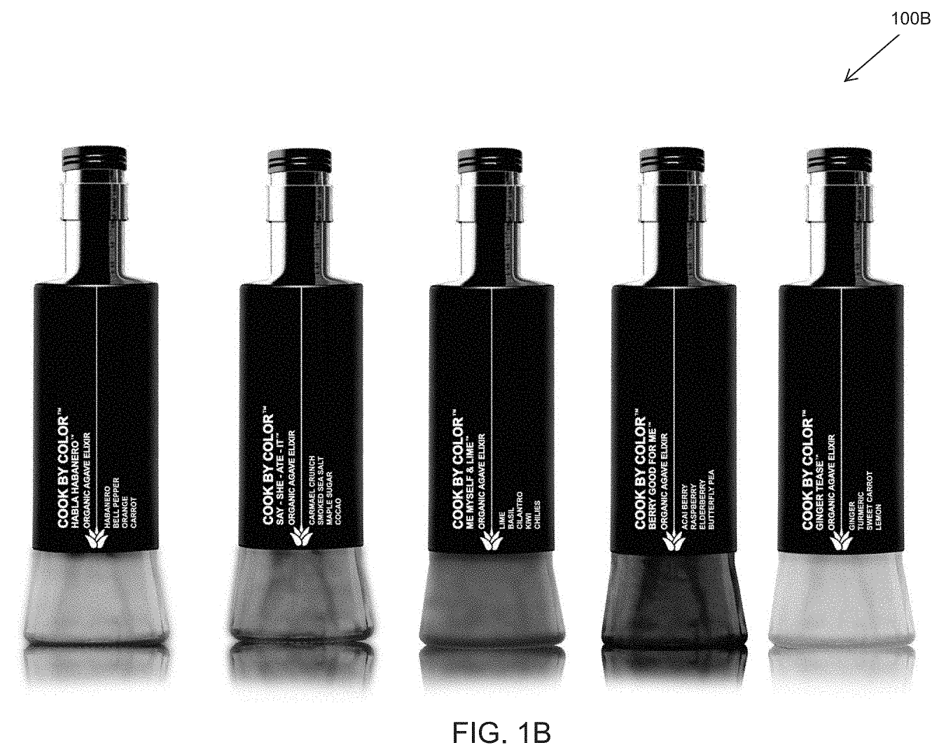

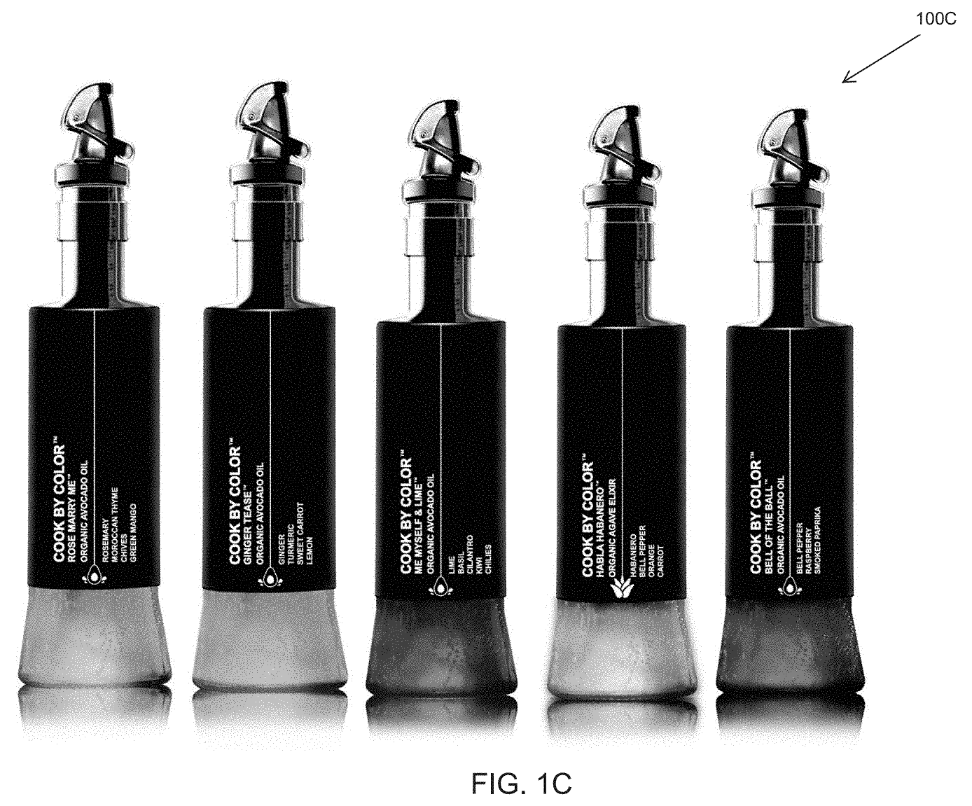

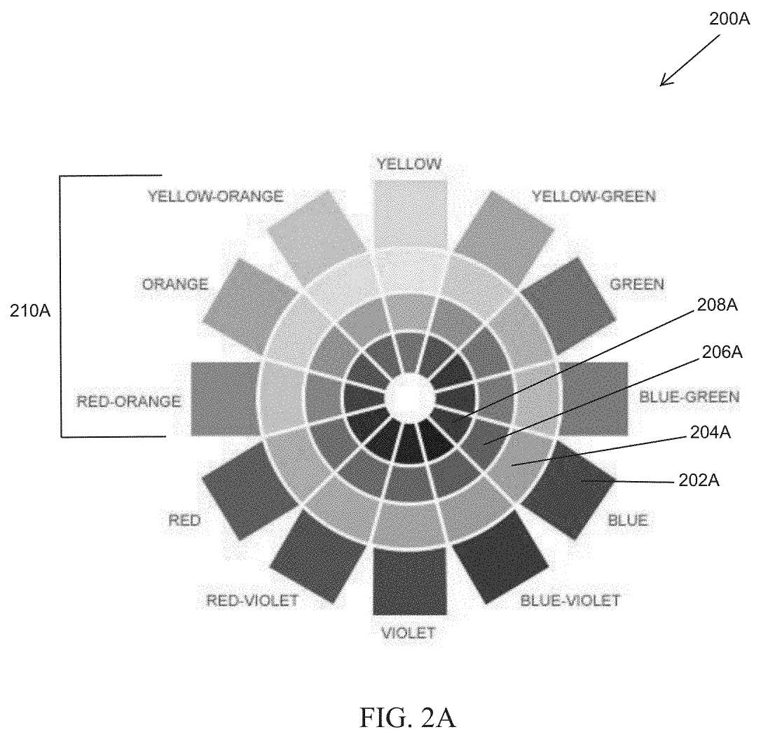

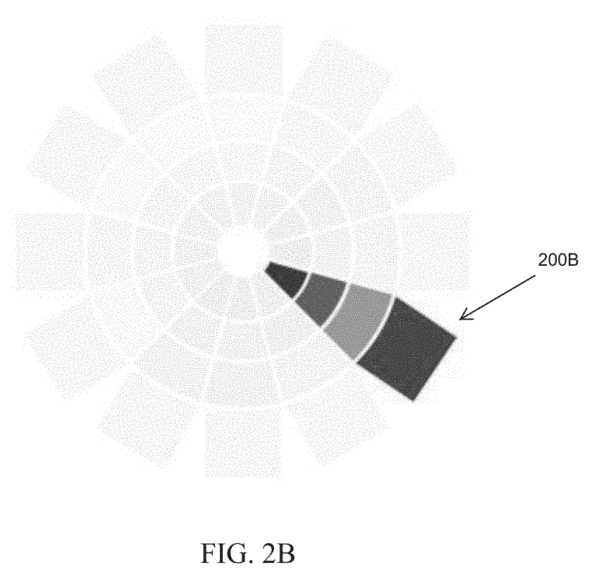

FIG. 1A shows examples of certain seasoning blends 100A of the present invention that have been prepared by combining ingredients derived from food sources from different food groups based upon the similarity of color of the food sources or ingredients. In the examples, the ingredients have been dried and/or powdered and mixed together in various quantities for inclusion in the seasoning blends. The similarity in color of the food sources is determined by the twelve color wheel illustrated in FIG. 2A.

Each of the ten different seasonings 100A shown in FIG. 1A includes ingredients derived from at least two of the following food groups: fruit, vegetable, and herb/spice. A food group is a collection of foods that share similar nutritional properties or biological classifications. For example, fruits contain carbohydrates, mostly in the form of sugar as well as important vitamins and minerals. Examples of fruits that can be used in the seasonings 100A of the present invention include: Banana, Lime, Kiwi, Lemon, Orange, Raspberry, Vanilla, Watermelon, Elderberry, Acai, Butterfly Pea, Blackberry, Cherry, Apple, Strawberry, Grape, Juniper Berry, Pineapple, Peach, Avocado, Mango, Passion Fruit, Pomegranate, Plum, Pumpkin, and Blueberry. Vegetables are generally low in fat and carbohydrates, but high in vitamins, minerals and dietary fiber. Examples of vegetables that can be used in the seasonings 100A of the present invention include: Mushroom, Garlic, Onion, Carrot, Bell Pepper, Chili Pepper, Sweet Potato, Cacao, Beets, Black Truffle, Tomato, Spinach, and Turnip. Herbs/Spices are generally used in nutritionally insignificant quantities for the purpose of flavoring, coloring, and/or aromatic properties. Examples of herbs/spices that can be used in the seasonings 100A of the present invention include: Cilantro, Basil, Ginger, Turmeric, Paprika, Sesame Seeds, Salt, Black Pepper, Cinnamon, Nutmeg, Butterfly Pea, Annatto, Saffron, Cumin, Coriander, Mint, Sage, Poppyseeds, Cardamom, Sumac, Thyme, Star Anise, Oregano, Tarragon, Lavender, Dill, Lemongrass and Cloves.

As stated above, each of the seasoning blends 100A of the present invention includes ingredients derived from at least two of the following food groups: fruit, vegetable, and herb/spice. It should be noted that any number, variety or combination of ingredients may used in the seasoning blends of the present invention. For example, the ingredients of seasoning 102A comprises of a fruit (Mango) and two herbs/spices (Rosemary and Chives) while the ingredients of seasoning 104A comprises of a vegetable (Cacao) and an herb/spice (Sea Salt). While seasoning 104A also comprises of ingredients caramel and maple sugar, both of which do not fall under a fruit, vegetable or herb/spice food group, the fact that the ingredients of seasoning 104A comprise of at least one vegetable and one herb/spice is sufficient for seasoning 104A to fall within the scope of the present invention. However, in other examples of the present invention, all of the ingredients used in each of the seasonings of the present invention are derived from at least two of the following food groups: fruit, vegetable, and herb/spice.

In other examples of the present invention, all of the ingredients in each of the seasoning blends must be derived from all three of the following food groups: fruit, vegetable and herb/spice. For example, all of the ingredients of seasoning 106A include a fruit (Lemon), a vegetable (Sweet Carrot), and two herbs/spices (Ginger and Turmeric). Similarly, in another example, all of the ingredients of seasoning 108A include two fruits (Lime and Kiwi), a vegetable (Chilies), and two herbs/spices (Basil and Cilantro). Thus, all of the ingredients in the seasoning blend of the present invention may include at least one fruit, at least one vegetable and at least one herb/spice. Adding fruits and vegetables to herbs/spices takes out the starchiness of the herbs/spices and provides a much more wholistic flavor compared to seasonings that only use ingredients derived from only one of the food groups.

It should also be known that any of the seasoning blends shown in FIG. 1A or otherwise consistent with the present invention may be combined with, or infused into, any consumable liquids used with cooking such as oils (e.g. olive oil, avocado oil, coconut oil, castor oil etc.), sweeteners (e.g., agave, honey, syrup etc.) sauces (etc. soy sauce, tomato sauce, pesto sauce etc.), wines etc. For example, FIG. 1B shows examples of some of the seasoning blends of FIG. 1A combined with an Agave sweetener base and FIG. 1C shows examples of some of the seasoning blends of FIG. 1A combined with an Avocado oil base. Optionally, in addition to the seasoning blends infused with the consumable liquids, THC or CBD oil may also be added or infused with the consumable liquids, along with the seasonings.

Regardless of the combination of ingredients that are used from the three different food groups noted above (fruit, vegetable, and herb/spice), each of the food sources in which the ingredients are derived may also be similar in color such that the color is in the same color group, as shown in the color wheel in FIG. 2A. In other examples, the color of the ingredients themselves may be similar in color such that the color is in the same color group, as shown in the color wheel in FIG. 2A.

FIG. 2A is an illustration of a color wheel 200A comprising of twelve different color families. Each color family includes a hue and various tints, tones and shades of that hue. This twelve color family wheel 200A is one of the most common color wheels used to label and categorize different colors.

The twelve colors around on the outermost part of the color wheel 200A are known as hues 202A. A hue 202A is the purest or brightest form of a color. Typically, hues 202A are colors that have not been mixed with white, gray, or black. As labeled in FIG. 2A, the twelve color hues 202A shown on the color wheel 200A consist of Yellow, Yellow-Green, Green, Blue-Green, Blue, Blue-Violet, Violet, Red-Violet, Red, Red-Orange, Orange, and Yellow-Orange. The next inner circle of colors from the outermost part of the wheel 200A is referred to as the tint 204A of each color hue 202A. A tint 204A is the hue mixed with white. While the color wheel 200A illustrated in FIG. 2A shows the tint 204A of each hue 202A mixed with 50% white, it should be known that any percentage of white mixed with the hue 202A can be created and will be considered a tint of that hue.

The next inner circle of colors represents the tone 206A of each hue 202A. A tone 206A is the hue 202A mixed with true gray. While the color wheel 200A illustrated in FIG. 2A shows the tone 206A of each hue 202A mixed with 50% gray, it should be known that any percentage of gray mixed with the hue 202A can be created and will be considered a tone of that hue.

Lastly, the innermost circle of colors represents the shade 208A of each hue 202A. A shade 208A is the hue 202A mixed with black. While the color wheel 200A illustrated in FIG. 2A shows the shade 208A of each hue 202A mixed with 50% black, it should be known that any percentage of black mixed with the hue 202A can be created and will be considered a shade of that hue.

In all, each of the twelve hues 202A on the color wheel 200A illustrated in FIG. 2A plus all of the many tints, tones, and shades that are made with each hue 202A make up the colors on the color wheel 200A. Each segment of the color wheel, which consists of the hue and its many tints, tones and shades, is considered a color family 200B, as shown in FIG. 2B. Thus, FIG. 2A most accurately illustrates twelve color families 200B.

As stated above, each seasoning of the present invention may comprise of ingredients derived from food sources that are all within the same color group. A color group may be defined as one color family, two adjacent color families or a maximum of three adjacent color families 200B on the color wheel 200A. Therefore, the color wheel 200A comprises of twelve color groups. For example, as shown in FIG. 2A, 210A may be one color group on the color wheel 200A as it comprises of three adjacent color families: Red-Orange, Orange, and Yellow-Orange.

Thus, for example, if a seasoning of the present invention includes an ingredient derived from a food source that has a color that is in the Blue-Green family, then any other ingredient included in that seasoning must come from a food source that has a color that is either in the Blue-Green family, Blue family, or Green family, as illustrated on the color wheel 200A in FIG. 2A.

It should further be noted that while a color group may consist of three adjacent color families 200B on the color wheel 200A, all colors of the food sources used in a particular seasoning must be in color families 200B that are adjacent to one another within that color group. In other words, there should be no gaps between color families that are in the same color group. For example, if a seasoning blend includes an ingredient derived from a food source that is of a color that is in the Yellow family, then all other ingredients included in that seasoning cannot come from food sources that are of a color only found in the Green family. This is because the Green family is not adjacent to the Yellow family. If an ingredient derived from a food source that is of a color that is in the Green family is used with an ingredient derived from a food source that is of a color that is in the Yellow family, an ingredient derived from a food source that has a color that is in the Yellow-Green family must also be used in the seasoning blend to close the gap between the Yellow and Green family in the color group of the color wheel 200A shown in FIG. 2A. It should also be noted that because black/brown and white are colors not part of the color wheel, each of these two colors and their respective tints, tones and shades may also be considered as two separate color families and two separate color groups from the twelve color families and twelve color groups illustrated on the color wheel 200A of FIG. 2A.

In applying the color wheel 200A of FIG. 2A to the seasonings 100A of FIG. 1A, the seasoning 110A illustrated in FIG. 1A, for example, consists of a fruit (Raspberry), a vegetable (Bell Pepper) and an herb/spice (Smoked Paprika). The color of the food sources of all three ingredients in the seasoning 110A are from the same color group of the color wheel 200A. The color of raspberry is in the Red color family, the bell pepper would be a red bell pepper and thus, the color would also be in the Red color family, and the color of the smoked paprika would be in the Red-Orange family. Thus, all ingredients in the seasoning 110A illustrated in FIG. 1A are derived from food sources that all have a color that is in the same color group. It should be noted that while certain food sources (such as bell peppers, chilies, apples, or grapes) may be available in a variety of different colors (red, green, yellow, orange etc.), the color of the food source chosen to be used in the seasoning of the present invention must be in the same color group as all other food sources that are also used in that same seasoning. Thus, as stated above, while many different colors of bell peppers are available on the market, the color of the bell pepper that is used in seasoning 110A illustrated in FIG. 1A must be of a color found in either the Red family, Red-Orange family, or Red-Violet family of the color wheel 200A illustrated in FIG. 2A.

The following table represents the color families of the food sources of the ingredients used in the example seasoning blends of the present invention:

| Color Family | Ingredients |
|---|---|
| Red | Red Bell Pepper, Raspberry, Smoked paprika, |
| | Annatto, Beets, Cherry, Red Apple, |
| | Strawberry, Saffron, Sumac, Tomato, |
| | Pomegranate |
| Orange | Sweet Carrot, Habanero, Orange Bell Pepper, |
| | Orange, Cinnamon, Sweet Potato, Nutmeg, |
| | Peach, Pumpkin |
| Yellow | Ginger, Turmeric, Lemon, Banana, Pineapple, |
| | Mango, Yellow Passion Fruit, Yellow Bell |
| | Pepper |
| Green | Lime, Basil, Cilantro, Kiwi, Green chilis, |
| | Rosemary, Chives, Green Mango, Green |
| | Apple, Green Grape, Mint, Sage, Green |
| | Cardamom, Thyme, Oregano, Tarragon, Dill, |
| | Lemongrass, Avocado, Spinach, Green Bell |
| | Pepper |
| Blue | Juniper Berry, Blueberry |
| Violet | Acai, Elderberry, Butterfly Pea, Blackberry, |
| | Purple Grape, Lavender, Plum |
| Black/Brown | Sesame Seeds, Pepper Corn, Vanilla Bean, |
| | Black Salt, Caramel, Smoked Sea salt, Maple |
| | sugar, Cacao, Black Truffle, Blackberry, |
| | Cumin, Coriander, Black Poppyseeds, Black |
| | Cardamom, Star Anise, Cloves |
| White | Banana, Mushroom, Garlic, Onion, White |
| | Poppyseeds, Turnip |

It should be noted that a few of the ingredients in the above table may be derived from the same food source, which may have different colors (e.g. a bell pepper may be red, green, or yellow). However, regardless of the different colors available for the food source of the same ingredient, the color of the food source chosen to be used in the seasoning of the present invention must be in the same color group as all other ingredients used in the same seasoning.

It should also be noted that other examples of the seasonings of the present invention may include ingredients derived from food sources that all have a color that is only found in one color family or two adjacent color families on the color wheel 200A illustrated in FIG. 2A.

In another example, seasoning 108A illustrated in FIG. 1A consists of two fruits (Lime and Kiwi), a vegetable (Chilies) and two herbs/spices (Cilantro and Basil). The color of the food sources of all three ingredients in the seasoning 108A are from the same color group. In particular, the color of lime and kiwi is in the Yellow-Green color family, the color of the chilies (which would need to be a green chili) is in the Green color family, and the color of the cilantro and basil is in the Green family. Thus, all ingredients in the seasoning 108A illustrated in FIG. 1A are derived from food sources that are all of a color that is in the same color group.

The purpose of combining similar colored ingredients in each of the seasoning blends of the present invention harnesses the natural nutrient power of each seasoning blend. Additionally, combining same colored ingredients provides more complimentary flavorings between the ingredients in each blend. For example, red colored food sources (i.e. red apples, red bell peppers, red grapes) tend to be much sweeter than their green colored counterparts (i.e. green apples, green bell peppers and green grapes). Therefore, combining ingredients derived from similar colored food sources provides a much more complimentary overall flavor profile compared to the combination of ingredients derived from different colored food sources. Additionally, a seasoning blend that comprises of ingredients all derived from similar colored food sources provides a much more vibrant holistic color to the seasoning blend. The creation of vibrant colors in the seasoning blends of the present invention promotes mental stimulation and good health.

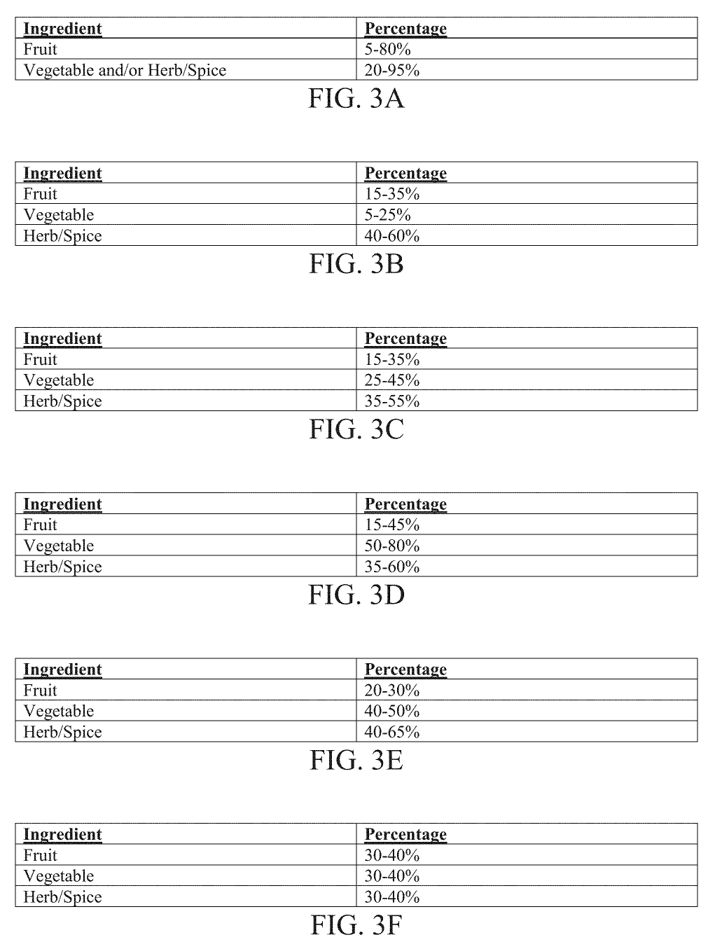

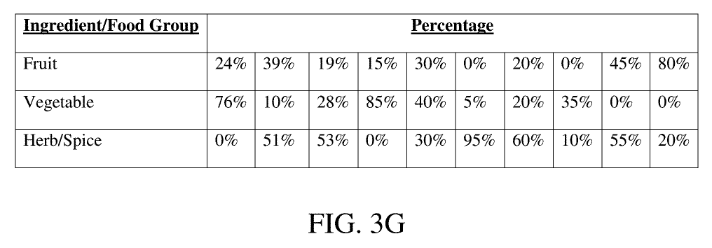

FIGS. 3A-3F are tables showing the categories of food groups included in the seasonings of the present invention, along with examples of percentage ranges of the food groups that may be found in each of the seasonings.

As shown in FIG. 3A, on example of a seasoning of the present invention may be comprised of 5-80% fruit and 20-95% of a vegetable and/or herb/spice. FIGS. 3B-3F are tables showing additional examples of the percentage ranges of the food groups that may be found in each of the seasonings. As shown in FIGS. 3B-3F, each seasoning may comprise of at least one fruit, at least one vegetable, and at least one herb/spice having various percentage ranges. In these examples, the combination of fruit, vegetable and herb/spice when all three are used may range in combination from (i) 5-80%, 15-80%, 15-60%, 20-45%, 15-30% or 15-25% fruit; (ii) 5-85%, 10-80%, 5-40%, 10-45%, 5-30% or 10-35% vegetable; and (iii) 10-95%, 20-95%, 10-60%, 20-60%, 50-60% herb/spice. The below tables show examples of different ingredients in different colored seasonings 100A of the present invention. It should be noted that each seasoning below includes ingredients that are consistent with the percentages of the table shown in FIG. 3A. Furthermore, each of the seasonings below also include ingredients derived from food sources that are of a color in the same color group.

White Seasoning

Mushroom Powder
Dried Onion
Dried Garlic
Dehydrated Banana

Green Seasoning

Lime Flavor
Dried Cilantro
Kiwi Powder
Dried Basil
Green Chili Pepper, Dried

Yellow Seasoning

Dried Ginger
Dried Turmeric
Dehydrated Carrot
Lemon Flavor

Orange Seasoning

Habanero Chili Pepper
Orange Flavor
Red Bell Pepper
Dehydrated Carrot

Red Seasoning

Red Bell Pepper
Raspberry Powder
Smoked Paprika

Yellow-Orange Seasoning

Cinnamon Powder
Dried Nutmeg
Dried Sweet Potato
Dried Banana Flakes

Yellow-Green Seasoning

Dried Rosemary
Dried Chives
Mango Powder

Violet Seasoning

Watermelon Powder
Elderberry Powder
Acai Powder
Butterfly Pea

Further, FIG. 3G is a table that provides ten various combinations of percentages of fruits, vegetable and herbs/spices taken from similar colored foods that may be combined together to create the seasoning blends of the present invention. In each combination provided in FIG. 3G, the percentage fruit, vegetable and herb/spice used in combination may be comprised of one or more fruit, vegetable or herb/spice that together equal the approximate percentage of the combination. For example, the total percentage fruit in the combination may consist of a combination of watermelon and acai powder, whereas the total percentage of vegetable in a mix may be a combination of mushroom powder and dried onion powder, granules or flakes.

In use, the seasoning blends of like color are derived from dried fruits, vegetables and herbs/spices that are ground into granules, powder and or flakes and that are combined in the various percentage set forth above, and can be bottled and sold. As shown in FIGS. 1B and 1C, any of these seasoning blends may be infused into consumable liquids (as set forth above). For example, a 350 ml bottle of consumable liquids may contain ¼ of a teaspoon of seasoning blend to a Tablespoon of seasoning blend, or more preferable ½ a teaspoon, one teaspoon, ¼ of a Tablespoon, ½ a Tablespoon or ¾ of the Tablespoon of the seasoning blend in each 350 ml bottle of consumable liquid. Optionally and additionally, THC and CBD oil (with or without THC) may also be added to the consumable liquids with the seasonings. For each 350 ml bottle with infused seasoning, anywhere from 5-300 mg of THC to CBD oil may be added per 350 ml, or more preferable 10-100 mg or 25-50 mg. Alternatively, THC or CBD oil may added to the consumable liquids at a rate such that per serving of the consumable liquid an average dose of anywhere from 5-50 mg of THC or CBD oil is provided.

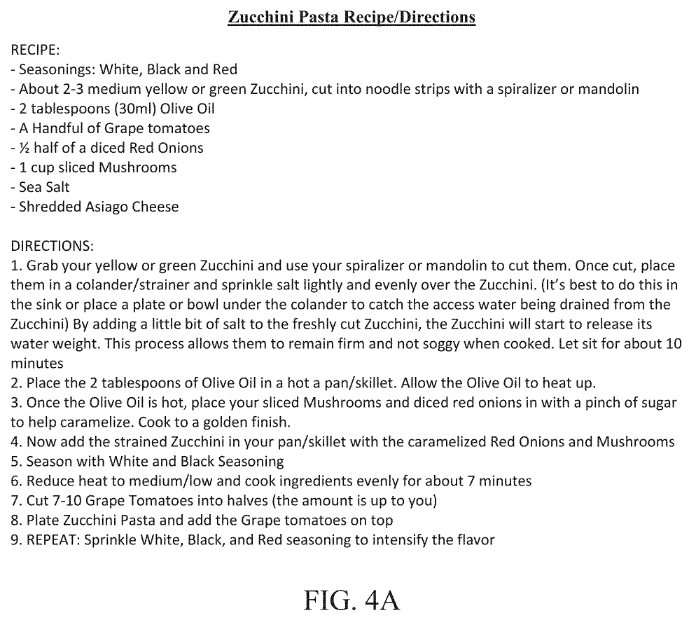

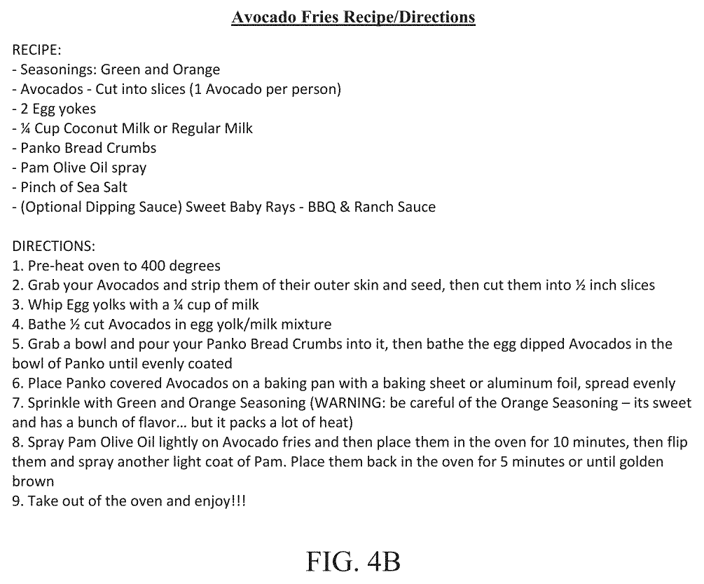

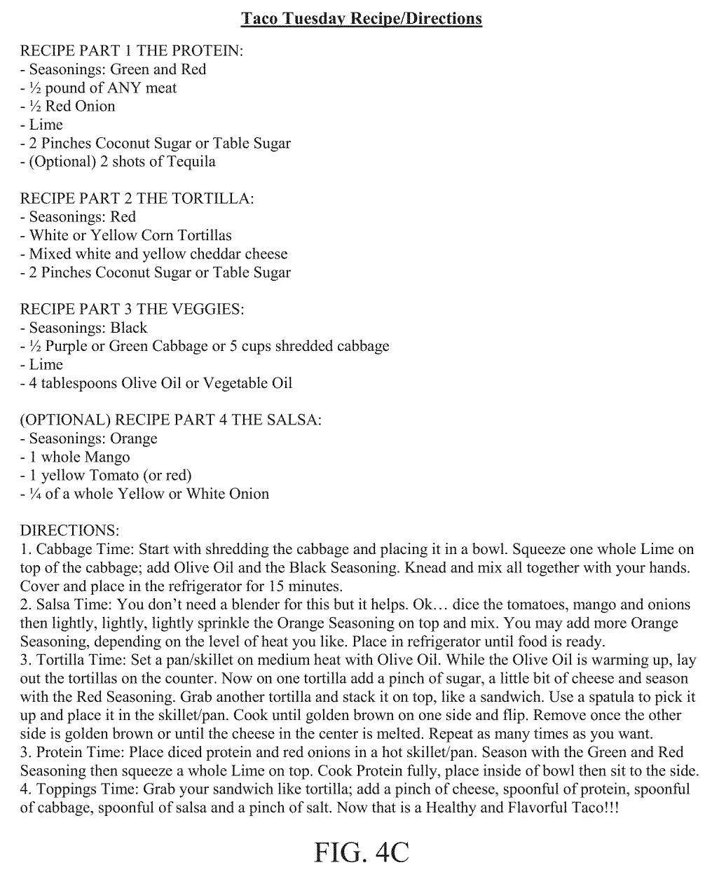

Once the seasoning blends are created, recipes can be created that provide for the use of specific season blends and that call out the seasoning blends in the recipe by color or by the brand name of the seasoning blend. For example, FIGS. 4A-4C are example recipes and corresponding cooking instructions that refer to the seasonings of the present invention by color rather than by the ingredients of the seasoning.

FIGS. 4A-4C are examples of recipes and corresponding cooking instructions that refer to the different seasonings of the present invention by their color to simplify cooking and cooking instructions. As illustrated, by creating seasoning blends with ingredients, the combination of which is derived from food sources having a color in the same color group, cooking can be simplified and recipes can be designed to refer to different seasonings by color rather than by the ingredients within the seasoning.

For example, shown in FIG. 4A is an example of a recipe and directions for cooking a Zucchini Pasta dish. The instructions specifically refer to the seasonings that are to be used when preparing the Zucchini Pasta by the color of the seasoning rather than by the ingredients of the seasoning. For example, while seasoning 110A comprises of red bell pepper, raspberry powder and smoked paprika, it is referred to as “Red Seasoning.” By referring seasoning 110A as “Red Seasoning,” the cook or user is not required to read any labels of any seasoning bottles, thus simplifying the cooking process.

In other examples, it should also be known that the seasonings of the present invention may also be referred to under any trade or brand name. For example, rather than referring to seasoning 110A as “Red Seasoning,” seasoning 110A may be referred under a trade name such as “Bell of the Ball.”

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

1. A seasoning blend for flavoring food products, where the seasoning blend comprises a combination of ingredients derived from at least two of the following food groups: fruit, vegetable and herb/spice.

2. The seasoning blend of claim 1, where all the ingredients are exclusively derived from at least one fruit, at least one vegetable and at least one herb/spice.

3. The seasoning blend of claim 1, where the seasoning blend is infused with a consumable liquid.

4. The seasoning blend of claim 3, where the consumable liquid is agave or oil.

5. The seasoning blend of claim 2, where the seasoning blend comprises of 15-35% fruit, 5-25% vegetable, and 40-50% herb/spice.

6. The seasoning blend of claim 2, where the seasoning blend comprises of 15-45% fruit, 50-80% vegetable, and 35-60% herb/spice.

7. The seasoning blend of claim 2, where the seasoning blend comprises of 30-40% fruit, 30-40% vegetable, and 30-40% herb/spice.

8. The seasoning blend of claim 3, where THC or CBD oil is added to the seasoning blend infused with a consumable liquid.

9. The seasoning blend of claim 5, where the at least one fruit is selected from a group consisting of: Banana, Lime, Kiwi, Lemon, Orange, Raspberry, Vanilla, Watermelon, Elderberry, Acai, Butterfly Pea, Blackberry, Cherry, Apple, Strawberry, Grape, Juniper Berry, Pineapple, Peach, Avocado, Mango, Passion Fruit, Pomegranate, Plum, Pumpkin, and Blueberry.

10. The seasoning blend of claim 5, where the at least one vegetable is selected from a group consisting of: Mushroom, Garlic, Onion, Carrot, Bell Pepper, Chili Pepper, Sweet Potato, Cacao, Beets, Black Truffle, Tomato, Spinach, and Turnip.

11. The seasoning blend of claim 5, where the at least one herb or spice is selected from a group consisting of: Cilantro, Basil, Ginger, Turmeric, Paprika, Sesame Seeds, Salt, Black Pepper, Cinnamon, Nutmeg, Butterfly Pea, Annatto, Saffron, Cumin, Coriander, Mint, Sage, Poppyseeds, Cardamom, Sumac, Thyme, Star Anise, Oregano, Tarragon, Lavender, Dill, Lemongrass, and Cloves.

12. The seasoning blend of claim 5, where the color group consists of colors located in three adjacent color families on a twelve hue color wheel.

13. The seasoning blend of claim 5, where the color group consists of colors located in two adjacent color families on a twelve hue color wheel.

14. The seasoning blend of claim 5, where the color group consists of colors located in one color family on a twelve hue color wheel.

15. A seasoning blend for flavoring food products, where the seasoning blend comprises a combination of ingredients derived from (i) at least one fruit, (ii) at least one vegetable, and (iii) at least one spice or herb, where the colors of the at least one fruit, at least one vegetable and at least one herb/spice are all in the same color group.

16. The seasoning blend of claim 15 for flavoring food products further including a consumable liquid.

17. The seasoning blend of claim 16 for flavoring food products further including THC or CBD oil.

18. A seasoning blend for flavoring food products, where the seasoning blend comprises a combination of ingredients derived from (i) at least one dried fruit, (ii) at least one dried vegetable, and (iii) at least one spice or herb, where the colors of the at least one dried fruit, at least one dried vegetable and at least one herb/spice are all in the same color group.

19. (canceled)

20. (canceled)

21. (canceled)

22. (canceled)

23. (canceled)
